(19) United States
(12) Patent Application Publication
(10) Pub. No.: US 2011/0189516 A1
(43) Pub. Date: Aug. 4, 2011

(54) ALKALINE DRY BATTERY

(76) Inventors: Fumio Kato, Osaka (JP); Jun Nunome, Kyoto (JP); Harunari Shimamura, Osaka (JP)

(21) Appl. No.: 13/122,342

(22) PCT Filed: Sep. 14, 2009
(86) PCT No.: PCT/JP2009/004576

§ 371 Date: Apr. 1, 2011

(30) Foreign Application Priority Data
Nov. 21, 2008 (JP) 2008-298451

(51) Int. Cl. H01M 6/10; H01M 2/02

(52) U.S. Cl. 429/94; 429/164

(57) ABSTRACT

The present invention provides an alkaline dry battery improved in pulse discharge characteristic under high load in a low temperature atmosphere. The alkaline dry battery of the present invention includes: a hollow cylindrical positive electrode 2 placed in a cylindrical battery case 8 having a closed bottom; a negative electrode 3 placed in a hollow part of the positive electrode 2; a separator 4 arranged between the positive electrode 2 and the negative electrode 3; and an alkaline electrolyte solution, wherein the negative electrode 3 includes a porous zinc body, and the porous zinc body has a specific surface area of 200 cm²/g to 1000 cm²/g, both inclusive, controlled by roughening.

### TECHNICAL FIELD

The present invention relates to alkaline dry batteries.

### BACKGROUND ART

Alkaline dry batteries (alkali-manganese dry batteries) including a manganese dioxide positive electrode, a zinc negative electrode, and an aqueous alkaline solution as an electrolyte solution are adaptable to a wide variety of applications, and are inexpensive. For these reasons, the alkaline dry batteries have widely been and are being used as power sources of various devices.

In some commercially available alkaline dry batteries, a negative electrode formed by dispersing zinc powder in a gelled alkaline electrolyte solution dissolving a gelled component (polyacrylic acid etc.) is employed. In the negative electrode containing the zinc gel, electrical bonding/contact among particles of the zinc powder (conductive network) is insufficient, and ion conductivity of the gelled alkaline electrolyte solution is low. Therefore, utilization ratio of zinc in the negative electrode using the zinc gel is likely to decrease in high rate discharge. To address the problem, Patent Documents 1 to 3 propose a technology of using a porous zinc body (in the form of a ribbon, wool, metal foam, etc.) as the negative electrode to improve the conductive network, and using an alkaline electrolyte solution which does not contain the gelled component, and has high ion conductivity to increase the zinc utilization ratio.

### CITATION LIST

### Patent Documents

[Patent Document 1] Japanese Translation of PCT International Application No. 2002-531923
[Patent Document 2] Japanese Translation of PCT International Application No. 2008-518408
[Patent Document 3] Japanese Patent Publication No. 2005-294225

### SUMMARY OF THE INVENTION

### Technical Problem

The inventors of the present invention have found that a sufficient discharge characteristic cannot be obtained by use of the porous zinc body (in the form of a ribbon, wool, metal foam, etc.) produced by the known technique taught by Patent Documents 1 to 3 when pulse discharge occurs under high load in a low temperature atmosphere.

### Solution to the Problem

In view of the foregoing, an alkaline dry battery of the present invention includes: a hollow cylindrical positive electrode placed in a cylindrical battery case having a closed bottom; a negative electrode placed in a hollow part of the positive electrode; a separator arranged between the positive electrode and the negative electrode; and an alkaline electrolyte solution, wherein the negative electrode includes a porous zinc body, and the porous zinc body has a specific surface area of 200 cm²/g to 1000 cm²/g, both inclusive, controlled by roughening. The roughening includes various types of physical or chemical treatments, and includes every treatment through which the specific surface area of the porous zinc body is controlled to 200 cm²/g to 1000 cm²/g, both inclusive.

### Advantages of the Invention

The present invention can provide an alkaline dry battery which is improved in pulse discharge characteristic under high load in a low temperature atmosphere.

### BRIEF DESCRIPTION OF THE DRAWINGS

FIG. 1 is a front view illustrating an alkaline dry battery of Example 1, partially cut away.

FIGS. 2(a) and 2(b) schematically show how to form a negative electrode by winding a porous zinc sheet.

FIG. 3 is a front view illustrating an alkaline dry battery using a gelled negative electrode, partially cut away.

FIG. 4 is a table indicating characteristics of porous zinc sheets used in dry batteries of Example 1 and Comparative Example 1.

FIG. 5 is a table indicating discharge characteristics of dry batteries of Example 1 and Comparative Examples 1 and 2.

FIG. 6 is a table indicating discharge characteristics of dry batteries of Example 2 and Comparative Examples 1 and 3.

FIG. 7 is a table indicating discharge characteristics of dry batteries of Example 3 and Comparative Example 1.

FIG. 8 is a table indicating discharge characteristics of dry batteries of Example 4 and Comparative Examples 1 and 4.

FIG. 9 is a table indicating discharge characteristics of dry batteries of Example 5 and Comparative Examples 1 and 5.

FIG. 10 is a table indicating discharge characteristics of dry batteries of Example 6 and Comparative Example 1.

FIG. 11 is a table indicating discharge characteristics of dry batteries of Example 7 and Comparative Example 1.

### DESCRIPTION OF EMBODIMENTS

Before the description of embodiments, the inventors' study will be described below.

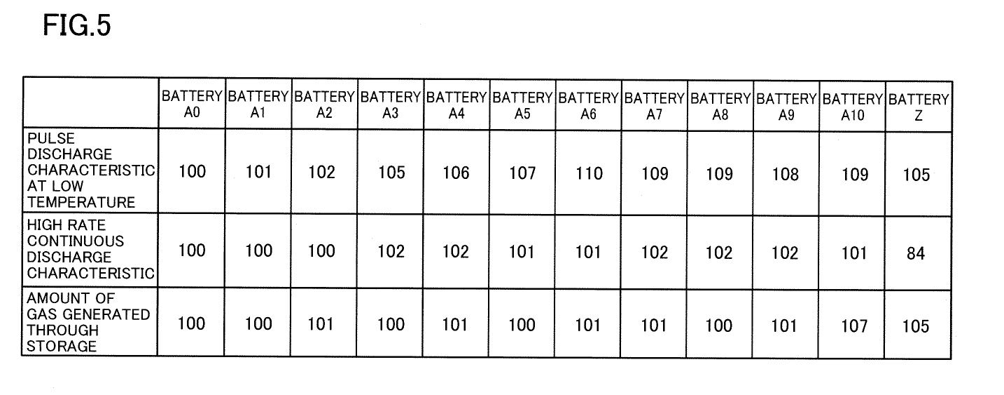

An alkaline dry battery using zinc gel is configured as shown in FIG. 5. A hollow cylindrical positive electrode pellet 102 is placed in a battery case 101, and a negative electrode 103 is arranged inside the positive electrode pellet 102 with a separator 104 interposed therebetween. In such an alkaline dry battery, electrical bonding/contact among zinc powder particles (conductive network) is insufficient, and ion conductivity of the gelled alkaline electrolyte solution is low. Thus, use of the porous zinc body is taken into consideration.

However, as described above, with use of the porous zinc body taught by Patent Documents 1 to 3 (in the form of a ribbon, wool, foam metal, etc.), a discharge reaction of zinc in the negative electrode cannot occur sufficiently when pulse discharge occurs under high load in a low temperature atmosphere, and the discharge characteristic is not satisfactory. The inventors' study showed that the porous zinc body taught by Patent Documents 1 to 3 has a small specific surface area (a surface area per unit mass), and a pulse discharge characteristic under high load at low temperature is low as compared to the zinc powder.

As a result of the inventors' study to address the newly found problem, the inventors have achieved the present invention. Illustrative embodiments of the present invention will be described below.

### First Embodiment

An alkaline dry battery of a first embodiment includes a hollow cylindrical positive electrode placed in a cylindrical battery case having a closed bottom, a negative electrode placed in a hollow part of the positive electrode, a separator arranged between the positive and negative electrodes, and an alkaline electrolyte solution. The negative electrode includes a porous zinc body, and the porous zinc body has a specific surface area of 200 cm²/g to 1000 cm²/g, both inclusive, controlled by roughening. The porous zinc body may be in the form of a ribbon or a foam as taught by Patent Documents 1-3, compressed fibers, filaments, or strands, etc.

The specific surface area of zinc metal is measured by krypton gas adsorption. The known porous zinc body (in the form of a ribbon, wool, a foam metal, etc.) taught by Patent Documents 1 to 3 has a specific surface area of smaller than 100 cm²/g, which is significantly smaller than a specific surface area of zinc powder for batteries produced by gas atomization: 300-500 cm²/g. Thus, with use of the negative electrode made of the known porous zinc body, the conductive network is improved, and utilization ratio of zinc is improved. However, reactivity of zinc is low in instantaneous pulse discharge, thereby reducing discharge voltage of the battery. The disadvantage is significant particularly in a low temperature atmosphere in which ion mobility is reduced, and is critical when the dry battery is applied to a digital still camera etc. in which a cutoff voltage is high.

In the present embodiment, a porous zinc body having a specific surface area of 200 cm²/g or larger controlled by roughening is used, thereby keeping the reactivity of zinc sufficiently high in the instantaneous pulse discharge, and keeping the discharge characteristic high. However, when the specific surface area of the porous zinc body is too large, corrosion of zinc is likely to occur, thereby generating gas. This may lead to increase in internal pressure of the battery, or leakage of the electrolyte. In this point of view, the specific surface area of the porous zinc body is limited to 1000 cm²/g or smaller. To control the specific surface area in this range, the porous zinc body is roughened. The roughening may be performed after, or simultaneously with the production of the porous zinc body. The porous zinc body may be made of a material which is roughened in advance.

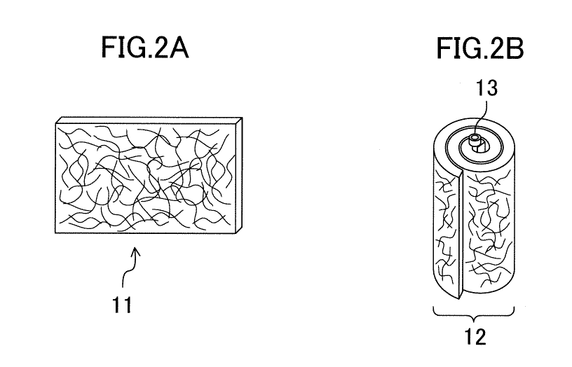

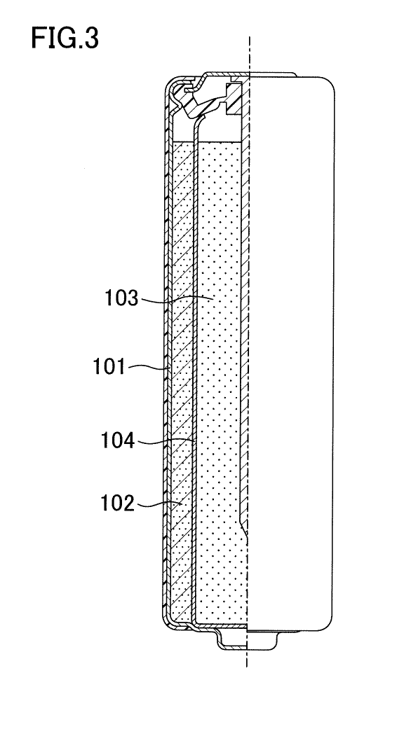

The negative electrode is preferably formed by winding a porous zinc sheet, which is the porous zinc body in the form of a sheet. The porous zinc body is required to be cylindrical, or columnar to be used as the negative electrode of the alkaline dry battery. To form the cylindrical or columnar porous body, a predetermined amount of the porous zinc body is placed in a hollow part of an outer cylindrical mold, and then a piston-shaped inner mold is used to directly compression-molding the porous zinc body. In this method, however, burrs or fins of the porous zinc body enter a clearance between the outer and inner molds, and troubles frequently occur in mass production. In actual mass production, winding a flat porous zinc sheet 11 into a cylindrical (columnar) negative electrode 12 as shown in FIG. 2 is advantageous in terms of cost etc. In this case, a discharge reaction (oxidation) of zinc in the alkaline dry battery proceeds from an outer circumference of the negative electrode facing the positive electrode toward the center of the battery. Therefore, a current collector 13 is preferably provided in the center to collect current from the negative electrode.

The porous zinc sheet is wound around a current collector pin which is made of metal, and is connected to the porous zinc sheet by welding or soldering. The current collector pin is preferably positioned substantially at the center of the negative electrode in a cross section perpendicular to a center axis of the battery case. The discharge reaction (oxidation) of zinc in the alkaline dry battery proceeds from the outer circumference of the negative electrode facing the positive electrode toward the center of the battery. Therefore, it is theoretically appropriate to collect the current of the negative electrode substantially at the center of the negative electrode in the cross section perpendicular to the center axis of the battery case (a position indicated by reference character 13 in FIG. 2). To obtain such a structure, the current collector metal pin is connected to an end of the porous zinc sheet by at least one of welding or soldering, and the sheet is wound around the pin as a starting point (a core). This is the easiest process to obtain the structure. The position of the current collector pin does not have any significant adverse effect as long as the current collector pin is positioned within a radius of 1 mm from the exact center.

The porous zinc sheet used in this case is preferably made of an aggregate of zinc fibers each having a diameter of 50 μm to 500 μm, both inclusive, and a length of 10 mm to 300 mm, both inclusive. The porous zinc sheet is required to have a mechanical strength enough to keep the shape of the negative electrode, and a surface area enough to cause a smooth discharge reaction. When the diameter of the zinc fiber is controlled to 50 μm or more, and the length is controlled to 10 mm or more, the mechanical strength enough to keep the shape of the negative electrode can be obtained. When the diameter of the zinc fiber is controlled to 2000 μm or less, preferably 500 μm or less, and the length is controlled to 300 mm or less, the specific surface area of 200 cm²/g to 1000 cm²/g, both inclusive, according to the present embodiment can easily be ensured.

The porous zinc sheet of the present embodiment having a specific surface area of 200 cm²/g to 1000 cm²/g, both inclusive, can relatively easily be produced by etching a surface of the porous zinc body with acid or alkali before the sheet is placed in the battery case. The specific surface area can be controlled by suitably adjusting the concentration and the temperature of acid or alkali used for the etching, and time for the etching.

Alternatively, the porous zinc sheet having a specific surface area of 200 cm²/g to 1000 cm²/g, both inclusive, can be produced by spraying zinc powder on the surface of the porous zinc sheet, and sintering the zinc powder on the porous zinc sheet before the negative electrode is placed in the battery case. The zinc powder having a large specific surface area is dispersed or sprayed on the sheet as it is, or as slurry prepared by mixing a binder as appropriate, and is heated in an inert atmosphere at about 400° C. to be sintered on and integrated with the surface of the sheet. Thus, the porous zinc sheet having a suitable specific surface area can be obtained.

In this case, the zinc powder dispersed on the surface of the porous zinc sheet preferably has an average particle diameter of 100 μm or smaller to obtain the preferred specific surface area.

The ratio of the zinc powder relative to the porous zinc sheet is preferably 1% by mass to 10% by mass, both inclusive. With the ratio of the zinc powder controlled to 1% by mass or higher, the specific surface area of the finally obtained sheet after the sintering is easily controlled to 200 cm²/g or higher. With the ratio of the zinc powder controlled to 10% or lower, fall of the zinc powder during the sintering can be reduced, thereby reducing the difficulty in the process of forming the porous zinc sheet.

In the present embodiment, the battery is preferably designed in such a manner that the mass ratio x/y of the alkaline electrolyte solution relative to zinc satisfies 1.0≦x/y≦1.5, where the mass of the alkaline electrolyte solution contained in the battery is x [g], and the mass of zinc contained in the negative electrode is y [g]. The value x/y is generally set to be less than 1.0 for an alkaline dry battery including a common gelled negative electrode using the zinc powder. When the ratio of the alkaline electrolyte solution is high, electrical bonding/contact among the zinc powder particles in the negative electrode (conductive network) is insufficient, or sedimentation of the zinc powder may occur. However, the battery of the present invention employs a negative electrode made of a porous zinc body, and does not suffer the above-described disadvantages. When the battery is designed to satisfy 1.0≦x/y, a sufficient amount of the electrolyte solution necessary for the discharge reaction of the zinc negative electrode can be supplied, and the utilization ratio of the negative electrode can be improved. When the battery is designed to satisfy x/y≦1.5, a necessary and sufficient amount of zinc can be contained in the battery, thereby providing the alkaline dry battery with high capacity.

In the present embodiment, balance of capacity between the negative electrode and the positive electrode, which is calculated on the conditions that MnO₂ contained in the positive electrode has a theoretical capacity of 308 mAh/g, and Zn contained in the negative electrode has a theoretical capacity of 820 mAh/g, is preferably 0.9 to 1.1, both inclusive. In the common alkaline dry battery including the gelled negative electrode containing the zinc powder, the balance of capacity between the negative electrode and the positive electrode is usually set to be higher than 1.1. This is because the utilization ratio of the gelled negative electrode is extremely low as compared with the utilization ratio of the positive electrode, and the gelled negative electrode has to be contained in the battery in an amount excessively greater than the theoretical amount. However, in the present embodiment, the utilization ratio of the negative electrode made of the porous zinc body is higher than that of the conventional gelled negative electrode is, and the balance of capacity between the negative electrode and the positive electrode can be set to be 1.1 or lower. Thus, the amount of the positive electrode material in the battery can be increased as compared with that in the conventional battery, thereby increasing the capacity of the battery. When the balance of capacity between the negative electrode and the positive electrode is set to 0.9 or higher, a necessary and sufficient amount of zinc can be contained in the battery, thereby increasing the capacity of the alkaline dry battery.

### —Description of Alkaline Dry Battery—

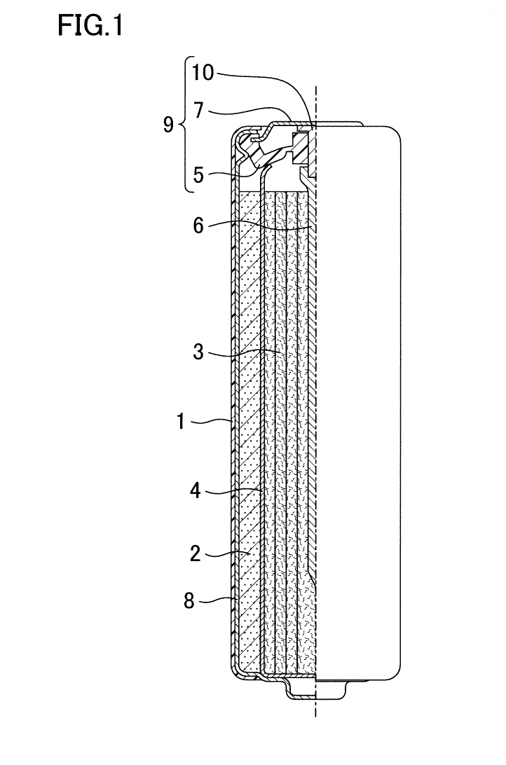

An alkaline dry battery of a first embodiment will be described below with reference to FIG. 1.

As shown in FIG. 1, the alkaline dry battery of the first embodiment includes a positive electrode made of a hollow cylindrical positive electrode material mixture pellet 2, and a negative electrode 3 made of a porous zinc sheet. The positive electrode material mixture pellet 2 and the negative electrode 3 are isolated by a separator 4. A cylindrical battery case 8 having a closed bottom is made of nickel-plated steel sheet. A graphite coating is formed inside the battery case 8.

The alkaline dry battery shown in FIG. 1 can be produced in the following manner. Specifically, a plurality of hollow cylindrical positive electrode material mixture pellets (a positive electrode) 2 containing a positive electrode active material, such as manganese dioxide etc., are placed in the battery case 8, and are pressed to be close contact with an inner surface of the battery case 8.

A wound columnar separator 4, and an insulating cap are placed inside the positive electrode material mixture pellet 2, and an electrolyte solution is injected to wet the separator 4 and the positive electrode material mixture pellet 2.

After the injection, a negative electrode 3 is placed inside the separator 4, and the battery case is filled with the alkaline electrolyte solution. The negative electrode 3 is produced in advance by winding a sheet of a porous zinc body which is a negative electrode active material. The porous zinc sheet is formed by compressing zinc fibers each having a diameter of 50 μm to 500 μm, both inclusive, and a length of 10 mm to 300 mm, both inclusive. The alkaline electrolyte solution is made of an potassium hydroxide aqueous solution, to which an anionic surfactant, and a quaternary ammonium salt-based cationic surfactant are added, and an indium compound, a bismuth compound, a tin compound, etc. are added as needed. The negative electrode 3 has a specific surface area of 200 cm²/g to 1000 cm²/g, both inclusive, controlled by roughening.

The negative electrode 3 is columnar, and a current collector pin 6 made of metal is provided on a center axis thereof. A head of the current collector pin 6 protrudes from the porous zinc sheet, and has a recess which is opened upward. Before placing the negative electrode 3 inside the separator 4, a negative electrode intermediate part 10 is fitted in the recess of the current collector pin 6. The negative electrode intermediate part 10 is integrated with a resin sealing plate 5, and a bottom plate 7 which also functions as a negative electrode terminal, thereby constituting a negative electrode terminal structure 9. With the negative electrode intermediate part 10 fitted in the recess formed in the head of the current collector pin 6, the current collector pin 6 and the bottom plate 7 are electrically connected. After the entire part of the negative electrode 3 is placed inside the separator 4, the negative electrode terminal structure 9 is inserted in an opening end of the battery case 8. The opening end of the battery case 8 is clamped onto a rim of the bottom plate 7 with a rim of the sealing plate 5 interposed therebetween, thereby bringing the opening end of the battery case 8 into close contact with the bottom plate with the sealing plate interposed therebetween.

Lastly, an outer surface of the battery case 8 is coated with an outer label 1. Thus, the alkaline dry battery of the present embodiment is obtained.

Examples of the present invention will be described in detail below. The present invention is not limited to the following examples.

### EXAMPLE

### Example 1, Comparative Example 1

### Production of Positive Electrode

A positive electrode was produced in the following manner. Electrolytic manganese dioxide and graphite were mixed in the weight ratio of 94:6. To the mixed powder, 1 part by weight (pbw) of an electrolyte solution (a 39 weight percent (wt. %) potassium hydroxide aqueous solution containing 2 wt. % of ZnO) relative to 100 pbw of the mixed powder was mixed, and the mixture was uniformly stirred and mixed with a mixer to granulate the mixture into a certain size. The obtained granules were press-molded using a hollow cylindrical mold, thereby producing a positive electrode material mixture pellet. Electrolytic manganese dioxide used was HH-TF manufactured by Tosoh Corporation, graphite used was SP-20 manufactured by Nippon Graphite Industries, ltd.

### —Production of Negative Electrode—

Zinc fibers obtained by melt spinning (average diameter: 100 μm, average length: 20 mm, manufactured by Akao Aluminum Co., Ltd.) were immersed in 0.01 mol/l hydrochloric acid at room temperature to etch the zinc fibers. The etching corresponds to the roughening. Time for etching the zinc fibers was changed to produce ten different types of zinc fibers which were etched to the different degrees. After the etching, each of the different types of the zinc fibers was washed with water, dried, and compressed by a platen press to form a nonwoven sheet. Zinc fibers which were not etched were also produced and pressed into a nonwoven sheet. These zinc fiber sheets were porous zinc sheets each including gaps communicating with each other. Each of the zinc fiber sheets was cut into a rectangular shape of a predetermined dimension.

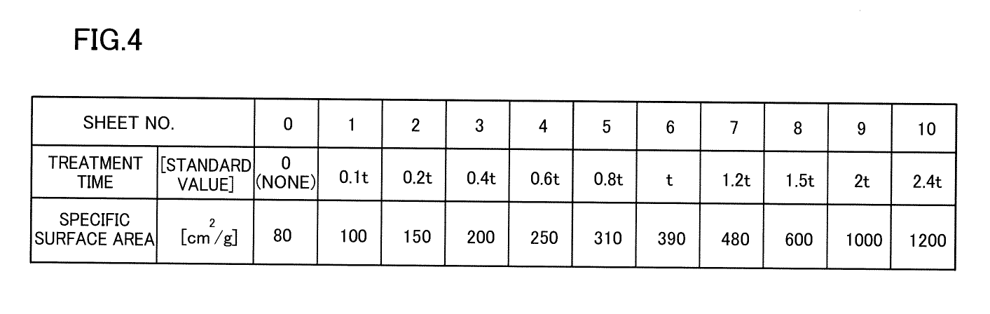

FIG. 4 shows specific surface areas of the ten types of zinc fiber sheets which were etched to the different degrees, and the zinc fiber sheet which was not etched. The etching time is indicated with reference to the time for etching the zinc fibers of the sheet No. 6. Specifically, the table indicates the number by which the time for forming the sheet No. 6 was multiplied. Using a device for measuring the specific surface area, ASAP-2010 manufactured by Shimadzu Corporation, the specific surface area of zinc was measured by degassing a sample of 7 g under vacuum at 120° C. for 2 hours, and allowing the sample to adsorb krypton gas.

To one side of each of the 11 types of the rectangular zinc fiber sheets, a brass current collector pin was connected and fixed by soldering. SnAgCu-based solder (melting point: 220° C.) was used for the soldering.

Each of the zinc fiber sheets was wound around the current collector pin like a jelly roll. In this way, 11 types of substantially columnar negative electrodes were produced. The current collector pin was positioned substantially on the center axis of the column, and a diameter of the column was smaller than an inner diameter of the positive electrode material mixture pellet by about 1 mm.

### —Assembly of Alkaline Dry Battery—

The positive electrode material mixture pellet obtained as described above was inserted in the battery case made of a nickel-plated steel sheet to cover an inner wall surface of the battery case. Then, a separator was inserted. The separator used was Vinylon lyocell composite nonwoven fabric manufactured by Kuraray Co., Ltd.

Then, a negative electrode intermediate part of a negative electrode terminal structure was fitted in a recess formed in a head of the current collector pin connected to the negative electrode, thereby coupling the negative electrode and the negative electrode terminal structure.

The columnar negative electrode was then inserted in a hollow part of the positive electrode material mixture pellet until half of the length of the columnar negative electrode was hidden in the positive electrode material mixture pellet. The separator was interposed between the positive electrode and the negative electrode.

To the separator and the negative electrode, a predetermined amount of a 33 wt. potassium hydroxide aqueous solution (containing 2 wt. % of ZnO) was injected using a narrow tube like an injection needle. Then, the remaining part of the negative electrode was fully inserted in the hollow part of the positive electrode material mixture pellet, and a bottom plate was clamped to produce an alkaline dry battery. Alkaline dry batteries produced by using sheets of Nos. 1-9 in FIG. 4 were Alkaline dry batteries A1-A9 of Example 1. Alkaline dry batteries produced by using sheets Nos. 0, 1, 2, and 10 were Alkaline dry batteries A0, A1, A2, and A10 of Comparative Example 1.

### Comparative Example 2

Dry battery Z of Comparative Example 2 was produced in the same manner as Example 1 except that a conventional gelled alkaline electrolyte solution in which zinc powder was dispersed was used as the negative electrode, and a mixture of 54 pbw of a 33 wt. % potassium hydroxide aqueous solution (containing 2 wt. % of ZnO), 0.7 pbw of crosslinked polyacrylic acid, and 1.4 pbw of crosslinked sodium polyacrylate was used as the gelled alkaline electrolyte solution. The mass of zinc and the mass of the alkaline electrolyte solution in the battery were the same as those of Example 1.

### —Evaluation of Discharge Characteristic—

### (1) Evaluation of High-Rate Pulse Discharge Characteristic at Low Temperature

The produced dry batteries were discharged at 1.5 W for 2 seconds in a constant temperature atmosphere of 0° C., and were discharged at 0.65 W for 28 seconds (pulse discharge). This was regarded as one cycle, and 10 cycles of the pulse discharge were performed per hour, and time required until a closed circuit voltage reached 0.9 V was measured. The longer time indicated the better high-rate pulse discharge characteristic at low temperature. A discharge test of ANSI C18.1M was applied to this evaluation with necessary modifications (a pattern of discharge was the same, but temperature and a cutoff voltage were set lower).

### (2) Evaluation of High-Rate Continuous Discharge Characteristic

The produced dry batteries were discharged at a constant current of 1 W in a constant temperature atmosphere of 21° C. to measure time required until the closed circuit voltage reached 0.9 V. The longer time indicated the better high-rate continuous discharge characteristic.

### (3) Evaluation of Amount of Gas Generated Through Storage

The produced dry batteries were stored in a constant temperature atmosphere of 60° C. for 2 weeks, and were returned to room temperature. Then, each of the dry batteries was disassembled in water to collect gas accumulated in the dry battery (gas generated through storage), and the amount of the gas was measured. The gas was generated through storage due to corrosion of zinc in the negative electrode. The smaller amount of the gas indicated the less corrosion of the zinc negative electrode, i.e., the better zinc negative electrode.

The results of the tests (1), (2), and (3) of the alkaline dry batteries were evaluated with reference to the results of Dry battery A0 of Comparative Example 1 regarded as 100.

FIG. 5 shows the evaluation results of the alkaline dry batteries of Example 1, and Comparative Examples 1 and 2. A comparison between Dry battery A0 of Comparative Example 1 and Dry battery Z of Comparative Example 2 will be discussed below.

Dry battery A0 included the negative electrode made of the zinc fiber sheet, and the specific surface area of the zinc fiber sheet was as small as 80 cm²/g. Dry battery Z included the conventional gelled negative electrode in which the zinc powder was dispersed, and the specific surface area of the zinc powder was as large as about 400 cm²/g. Due to the difference in specific surface area, the high-rate pulse discharge characteristic at low temperature of Dry battery A0 was lower than that of Dry battery Z was. However, Dry battery A0 had a significantly improved conductive network in the zinc fiber sheet as compared with the gelled electrode. Therefore, Dry battery A0 showed a significantly good high-rate continuous discharge characteristic at room temperature as compared with Dry battery Z. Further, Dry battery A0 was better than Dry battery Z was in that the amount of gas generated through storage was small.

A comparison between Dry batteries A3-A9 of Example 1 and Dry batteries of Comparative Examples 1 and 2 indicates that the high-rate pulse discharge characteristic at low temperature was as good as, or better than that of Dry battery Z when the specific surface area of the zinc fiber sheet of the negative electrode was 200 cm²/g or larger. The high-rate continuous discharge characteristic was as good as, or better than that of Dry battery A0, and the amount of gas generated through storage was as small as that of Dry battery A0. Dry battery A10 in which the specific surface area of the zinc fiber sheet was 1200 cm²/g showed a good high-rate pulse discharge characteristic at low temperature, and a good high-rate continuous discharge characteristic, but the amount of gas generated through storage was increased because the specific surface area was too large.

This indicates that the dry battery in which the high-rate pulse discharge characteristic and the high-rate continuous discharge characteristic are good, and the generation of gas is reduced can be provided when the specific surface area of the zinc fiber sheet is controlled to 200 cm²/g to 1000 cm²/g, both inclusive.

### Example 2, Comparative Example 3

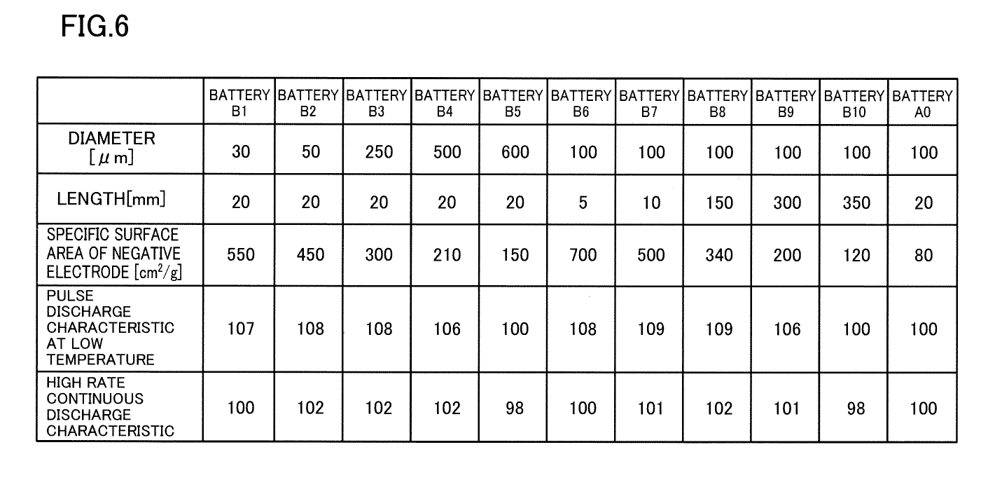

Dry batteries of Example 2 and Comparative Example 3 were produced in the same manner as Example 1 except that the diameter or length of the zinc fiber was changed. FIG. 6 shows the range of the diameter and length of the zinc fiber. FIG. 6 shows the discharge characteristics of Dry batteries B1-B4, and B6-B9 of Example 2, and Dry batteries B5 and B10 of Comparative Example 3.

In comparison with Dry battery A0 of Comparative Example 1, Dry batteries B1-B4, and B6-B9 had improved discharge characteristics. In particular, the discharge characteristic was good when the zinc fiber had a diameter of 50 μm to 500 μm, both inclusive, and a length of 10 mm to 300 mm, both inclusive. In Dry battery B5 and B10, the specific surface area of the zinc fiber sheet was smaller than 200 cm²/g, and therefore, the high rate continuous discharge characteristic was low, and the high rate pulse discharge characteristic at low temperature was not improved.

### Example 3

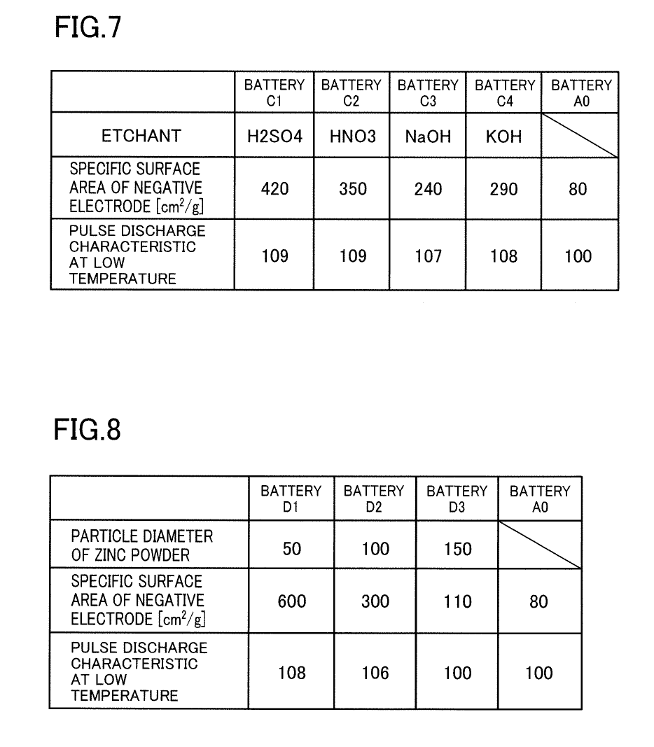

Dry batteries of Example 3 were produced in the same manner as Example 1 except that the sheets No. 6 of Example 1 were etched with different etchants. As shown in FIG. 7, the etchants used were sulfuric acid, nitric acid, a sodium hydroxide aqueous solution, and a potassium hydroxide aqueous solution. The etchants had the same concentration as the etchant used in Example 1 (0.01 mol/l), and the zinc fibers were etched for the same time as the zinc fibers of the sheet No. 6 shown in FIG. 4. FIG. 7 shows the high rate pulse discharge characteristics at low temperature of Dry batteries C1-C4 of Example 3.

In comparison with Dry battery A0 of Comparative Example 1, Dry batteries C1-C4 had significantly improved high rate pulse discharge characteristic at low temperature. Specifically, irrespective of the type of the etchant, the good discharge characteristic was obtained when the specific surface area of the zinc fiber sheet was 200 cm²/g to 1000 cm²/g, both inclusive.

### Example 4, Comparative Example 4

Dry batteries of Example 4 and Comparative Example 4 were produced in the same manner as Dry battery A0 of Comparative Example 1 except that zinc powder was dispersed and sintered on the sheet No. 0 of Comparative Example 1.

In Example 4 and Comparative Example 4, the zinc powder was obtained by gas atomization, and was classified using a vibration screen into three types of zinc powders having average particle diameters of 50 μm, 100 μm, and 150 μm, respectively. The three types of the zinc powders were sprayed onto three zinc fiber sheets of No. 0, respectively. The amount of the sprayed zinc powder was 5% by mass relative to the amount of zinc in the zinc fiber sheet. After the spraying, each of the zinc fiber sheets was wound, and was thermally treated in an argon atmosphere at 400° C. to sinter the zinc powder. Although SnAgCu-based solder connecting the current collector pin and the zinc fiber sheet was molten through the thermal treatment at 400° C., the current collector pin was fixed at the center of the negative electrode by the wound zinc fiber sheet, and the molten solder remained at the center. Therefore, the solder connected the current collector pin and the zinc fiber sheet again after cooling, thereby fixing the current collector pin at the center of the negative electrode. FIG. 8 shows the high rate pulse discharge characteristics at low temperature of Dry batteries D1 and D2 of Example 4, and Thy battery D3 of Comparative Example 4.

In Battery D3 of Comparative Example 4 in which the average particle diameter of the zinc powder was 150 μm, the specific surface area of the negative electrode was as small as 110 cm²/g, and the high rate pulse discharge characteristic was the same as that of Battery A0 of Comparative Example 1. In Dry batteries D1 and D2 of Example 4 in which the average particle diameter of the zinc powder was 100 μm or smaller, the specific surface area of the negative electrode was 300 cm²/g or larger. The high rate pulse discharge characteristic at low temperature was significantly improved as compared with that of Battery A0 of Comparative Example 1.

### Example 5, Comparative Example 5

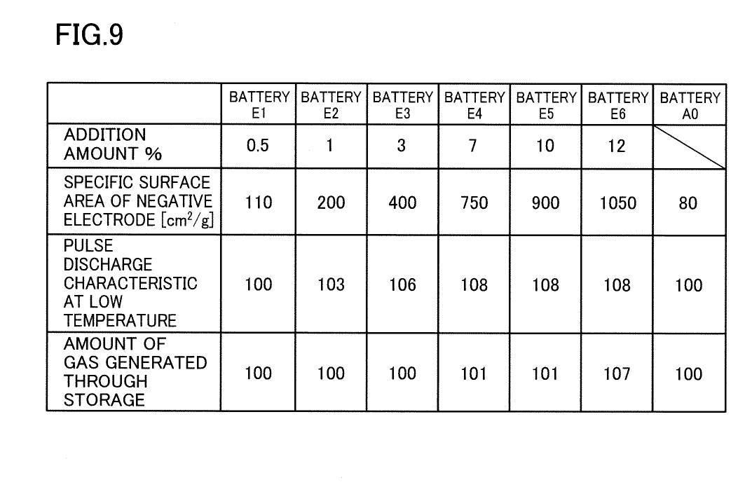

Dry batteries of Example 5 and Comparative Example 5 were produced in the same manner as Dry battery D1 of Example 4 except that the amount of the sprayed zinc powder was changed. The amount of the sprayed zinc powder having an average particle diameter of 50 μm was in the range of 0.5% by mass to 12% by mass relative to the amount of zinc in the zinc fiber sheet as shown in FIG. 9. FIG. 9 shows the high rate pulse discharge characteristics at low temperature, and the amounts of gas through storage of Dry batteries E2-E5 of Example 5, and Dry batteries E1 and E6 of Comparative Example 5.

Battery E1 of Comparative Example 5 in which the amount of the zinc powder was 0.5% by mass had a specific surface area of the negative electrode as small as 110 cm²/g, and showed the same high rate pulse discharge characteristic at low temperature as that of Battery A0 of Comparative Example 1. Battery E6 of Comparative Example 5 in which the amount of the zinc powder was 12% by mass had a specific surface area of the negative electrode as large as 1050 cm²/g, and showed the improved high rate pulse discharge characteristic at low temperature, but was significantly increased in amount of gas generated through the storage. In contrast, Dry batteries E2-E5 of Example 5 in which the amount of the zinc powder was 1% by mass to 10% by mass, both inclusive, and the specific surface area of the negative electrode was in the range of 200 cm²/g to 1000 cm²/g, both inclusive, had significantly improved high rate pulse discharge characteristic at low temperature, and the amount of the gas generated through the storage was approximately the same as that of Battery A0 of Comparative Example 1.

### Example 6

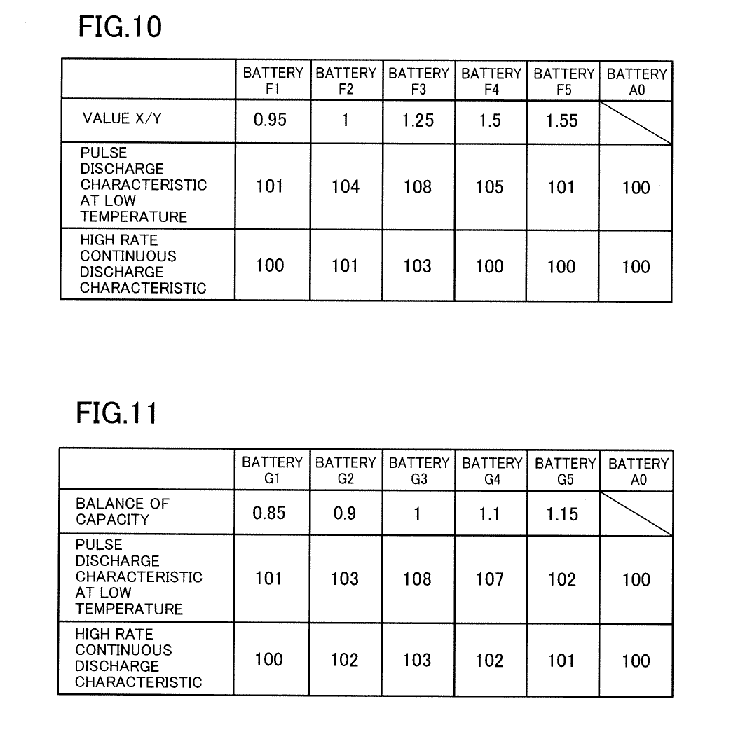

Dry batteries of Example 6 were produced in the same manner as Dry battery A6 of Example 1 except that mass of the alkaline electrolyte solution per dry battery x [g], and mass of zinc contained in the negative electrode y [g] were varied, while the value x+y was kept uniform. The values x and y were indicated as x/y values in FIG. 10. FIG. 10 shows the discharge characteristics of Dry batteries F1-F5 of Example 6.

The value x/y of Dry battery A0 of Comparative Example 1 was 1.10. Dry batteries F1-F5 showed improved discharge characteristics. In particular, the discharge characteristic was good in the range of 1≦x/y≦1.5.

### Example 7

Dry batteries of Example 7 were produced in the same manner as Dry battery A6 of Example 1 except that the amount of the positive electrode and the amount of the negative electrode per dry battery were varied, while a sum of volumes of the positive and negative electrodes was kept uniform. The amounts of the positive and negative electrodes were varied using, as an index, balance of capacity between the negative electrode and the positive electrode which is calculated on the conditions that MnO₂ contained in the positive electrode has a theoretical capacity of 308 mAh/g, and Zn contained in the negative electrode has a theoretical capacity of 820 mAh/g. The values of balance of capacity between the negative electrode and the positive electrode shown in FIG. 11 indicate the range of variations in the amount of the positive electrode and the amount of the negative electrode. FIG. 11 shows the discharge characteristics of Dry batteries G1-G5 of Example 7.

The balance of capacity between the negative electrode and the positive electrode of Dry battery X of Comparative Example 1 was 1.05. Dry batteries G1-G5 showed improved discharge characteristics. In particular, the discharge characteristic was good when the balance of capacity was in the range of 0.9 to 1.1, both inclusive.

### Other Embodiments

The above-described embodiments and examples are provided merely for the illustration purpose, and do not limit the present invention. For example, some of the above-described examples may be combined. For example, Examples 2 and 4 may be combined, or Examples 5 and 6 may be combined. Other examples may also be combined.

The fixing of the current collector pin to the zinc fiber sheet is not limited to soldering, and welding may be employed. The soldering and the welding may be combined.

The zinc fiber sheet may be replaced with the porous zinc body in the form of a ribbon or a foam described in Patent Documents 1 to 3, or a porous zinc body made of compressed fibers, filaments, or strands.

The roughening is not limited to the etching, or the spraying and sintering of the zinc powder. The surface of the porous zinc body, or a material thereof may mechanically be carved or scratched, or the porous zinc body may be made of a zinc material having a large specific surface area.

In the above-described examples, the zinc fiber sheet is made of pure zinc. However, to prevent corrosion, the zinc fiber sheet may be made of a zinc alloy containing a small amount of indium, bismuth, aluminum, calcium, magnesium, etc.

### INDUSTRIAL APPLICABILITY

The present invention provides an alkaline dry battery which is improved in pulse discharge characteristic under high load in a low temperature atmosphere, and can suitably be applied to digital still cameras etc.

### DESCRIPTION OF REFERENCE CHARACTERS

1 Outer label
2 Positive electrode material mixture pellet
3 Negative electrode
4 Separator
5 Resin sealing plate
6 Current collector pin
7 Bottom plate
8 Battery case
9 Negative electrode terminal structure
10 Negative electrode intermediate part
11 Porous zinc sheet
12 Negative electrode
13 Current collector

1. An alkaline dry battery comprising:
a hollow cylindrical positive electrode placed in a cylindrical battery case having a closed bottom;
a negative electrode placed in a hollow part of the positive electrode;
a separator arranged between the positive electrode and the negative electrode; and
an alkaline electrolyte solution, wherein
the negative electrode includes a porous zinc body, and
the porous zinc body has a specific surface area of 200 cm²/g to 1000 cm²/g, both inclusive, controlled by roughening.

2. The alkaline dry battery of claim 1, wherein
the negative electrode is formed by winding the porous zinc body in the form of a sheet.

3. The alkaline dry battery of claim 2, wherein
a porous zinc sheet which is the porous zinc body in the form of a sheet is wound around a current collector pin which is made of metal, and is connected to the porous zinc sheet by at least one of welding or soldering, and
the current collector pin is positioned substantially at the center of the negative electrode in a cross section perpendicular to a center axis of the battery case.

4. The alkaline dry battery of claim 2, wherein
a porous zinc sheet which is the porous zinc body in the form of a sheet is made of an aggregate of zinc fibers each having a diameter of 50 μm to 500 μm, both inclusive, and a length of 10 mm to 300 mm, both inclusive.

5. The alkaline dry battery of claim 2, wherein
a surface of a porous zinc sheet which is the porous zinc body in the form of a sheet is etched with acid or alkali before placing the porous zinc sheet in the battery case.

6. The alkaline dry battery of claim 2, wherein
zinc powder is sprayed on a surface of a porous zinc sheet which is the porous zinc body in the form of a sheet, and the zinc powder is sintered on the porous zinc sheet before placing the negative electrode in the battery case.

7. The alkaline dry battery of claim 6, wherein
the zinc powder has an average particle diameter of 100 μm or smaller.

8. The alkaline dry battery of claim 6, wherein
a ratio of the zinc powder relative to the porous zinc sheet is 1% by mass to 10% by mass, both inclusive.

9. The alkaline dry battery of claim 2, wherein
1.0<x/y<1.5, where x is mass of the alkaline electrolyte solution [g], and y is mass of zinc contained in the negative electrode [g], is satisfied.

10. The alkaline dry battery of claim 2, wherein
balance of capacity between the negative electrode and the positive electrode, which is calculated on the conditions that MnO₂ contained in the positive electrode has a theoretical capacity of 308 mAh/g, and Zn contained in the negative electrode has a theoretical capacity of 820 mAh/g, is 0.9 to 1.1, both inclusive.
